(19) United States
(12) Patent Application Publication
(10) Pub. No.: US 2018/0288248 A1
(43) Pub. Date: Oct. 4, 2018

(54) VOICE CONTROL SYSTEM FOR 3D PRINTER AND VOICE CONTROL METHOD FOR USING THE SAME

(71) Applicants: XYZPRINTING, INC., New Taipei City (TW); KINPO ELECTRONICS, INC., New Taipei City (TW)

(72) Inventors: Shyh-Yong SHEN, NEW TAIPEI CITY (TW); Yu-Chuan CHANG, NEW TAIPEI CITY (TW)

(21) Appl. No.: 15/623,095

(22) Filed: Jun. 14, 2017

(30) Foreign Application Priority Data
Mar. 29, 2017 (CN) 201710196993.8

(51) Int. Cl. H04N 1/00; G10L 15/26; G10L 15/22

(52) U.S. Cl. CPC H04N 1/00403; G10L 15/265; H04N 2201/0082; G10L 2015/223; G10L 15/22

(57) ABSTRACT

A voice control method for using a voice control system for a 3D printer includes performing an application program to receive a voice command; performing the application program to transmit the voice command to a voice recognition server for translating the voice command into a text command; performing the application program to determine type of the text command based on its contents; after determining the type of the text command to be a printer command, transmitting the printer command to a 3D printer; after determining the type of the text command to be an image file command, performing the application program to transmit the image file command to an image file database, performing the application program to search image files in the image file database, and downloading the found image file; and performing the application program to transmit the downloaded image file to the 3D printer.

### BACKGROUND OF THE INVENTION

### 1. Field of the Invention

The invention relates to three-dimensional (3D) printers and more particularly to a voice control system for 3D printer and voice control method for using the same.

### 2. Description of Related Art

3D printers are widely used in many applications in recent years due to quick advances of 3D printing technology, compactness of 3D printers, and price down of 3D printers. But a 3D printer is completely different from a conventional 2D printer in terms of mechanisms and printing methods. Hence, a user cannot operate a 3D printer by using the experience of using a 2D printer. To the contrary, the user has to learn how to operate a 3D printer from the beginning.

Operating steps of a 3D printer are very complicated. For example, the operating steps include controlling a printer head, controlling a printing platform, filling filament and removing same, obtaining a 3D image file, and performing a slice process to a 3D image file. However, it takes a lot of time for a user to learn above operating steps. And in turn, it increases difficulties of learning 3D printing. In addition, it can frustrate a user who desires to use a 3D printer. Thus, the need for improvement still exists.

### SUMMARY OF THE INVENTION

It is therefore one object of the invention to provide a voice control system for 3D printer and voice control method for using the same in which a voice command is issued to search a desired image file in an image file database, and the found image file is sent to a 3D printer for creating a 3D object so that learning how to operate a 3D printer is made easy and the learning time is decreased greatly.

For achieving above and other objects, the invention provides a voice control method for using a voice control system for a 3D printer, comprising performing an application program to receive a voice command; performing the application program to transmit the voice command to a voice recognition server for translating the voice command into a text command; performing the application program to deter nine type of the text command based on its contents; after determining the type of the text command to be a printer command, transmitting the printer command to a 3D printer for creating a 3D object; after determining the type of the text command to be an image file command, performing the application program to transmit the image file command to an image file database, performing the application program to search a plurality of image files in the image file database based on the image file command, and downloading the found image file; and performing the application program to transmit the downloaded image file to the 3D printer for creating a 3D object.

The invention has the following advantages and benefits in comparison with the conventional art: A user may issue a voice command to search a desired image file in an image file database, and the found image file is sent to a 3D printer for creating a 3D object. Therefore, learning how to operate a 3D printer is made easy and the learning time is decreased greatly.

The above and other objects, features and advantages of the invention will become apparent from the following detailed description taken with the accompanying drawings.

### BRIEF DESCRIPTION OF THE DRAWINGS

FIG. 1 is a block diagram of a voice control system for 3D printer according to a first embodiment of the invention;

FIG. 2 is a block diagram of a voice control system for 3D printer according to a second embodiment of the invention;

FIG. 3 is a flow chart of a voice control method for using the 3D printer according to the first embodiment of the invention;

FIG. 4 is a flow chart of processing an image file according to the first embodiment of the invention; and

FIG. 5 is a block diagram of a voice control system for 3D printer according to a third embodiment of the invention.

### DETAILED DESCRIPTION OF THE INVENTION

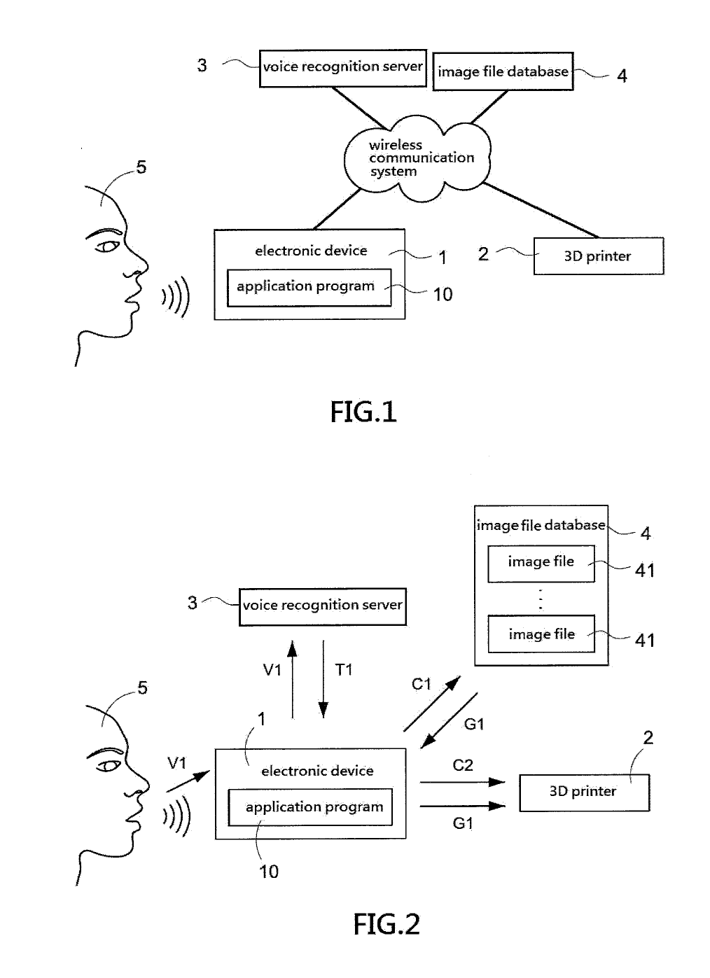

Referring to FIG. 1, a voice control system for 3D printer in accordance with a first embodiment of the invention comprises a voice control application program (called application program hereinafter) 10, a 3D printer 2, a voice recognition server 3, and an image file database 4 as discussed in detail below. In the invention, after performing the application program 10, the application program 10 may communicate with each of the 3D printer 2, the voice recognition server 3, and the image file database 4 via a wireless communication system (e.g., 4G LET, Wi-Fi, Bluetooth®, ZigBee or the like).

In the embodiment, the voice control system for 3D printer further comprises an electronic device 1 with the application program 10 disposed therein. After the application program 10 being performed by the electronic device 1, a wireless communication module (not shown) of the electronic device 1 may communicate with each of the 3D printer 2, the voice recognition server 3, and the image file database 4 via the wireless communication system. A microphone (not shown) in the electronic device 1 may receive a voice command from a user 5.

Referring to FIG. 2, a voice control system for 3D printer in accordance with a second embodiment of the invention is shown. The characteristics of the second embodiment are substantially the same as that of the first embodiment except the following: After the application program 10 being performed by the electronic device 1, the application program 10 may receive a voice command V1 from a user 5. For example, the user 5 transmits a voice command V1 to the microphone in the electronic device 1. In the embodiment, the electronic device 1 is a smart phone, smart watch, tablet computer, laptop computer or personal computer used by the user 5.

In the embodiment, the user 5 may install an application program 10 in the electronic device 1. A predetermined programming set (not shown) of the application program 10 may establish a wireless communication between the electronic device 1 (including the application program 10) and each of the 3D printer 2, the voice recognition server 3, and the image file database 4.

After establishing the wireless communication between the electronic device 1 and each of the 3D printer 2, the voice recognition server 3, and the image file database 4, the user 5 may transmit a voice command V1 to the electronic device 1 (i.e., the application program 10). And in turn, the application program 10 may perform the voice command V1 to cause the 3D printer 2 to print. It is envisaged by the invention that the user 5 does not have to learn the operating manual of the 3D printer 2 prior to using the 3D printer 2, thereby greatly decreasing time of learning the 3D printer 2 and greatly increasing the desire of using the 3D printer 2.

After the application program 10 receiving the voice command V1, the application program 10 may transmit the voice command V1 to the voice recognition server 3 via the wireless communication system. In the embodiment, the voice recognition server 3 is a Cloud voice recognition engine which is either software or hardware.

After the voice recognition server 3 receiving the voice command V1, the voice recognition server 3 may do an analysis of the voice command V1 in order to understand the voice command V1 and translate the voice command V1 into a text command T1. The text contents of the text command T1 is the same as the voice contents of the voice command V1. Thereafter, the voice recognition server 3 transmits the text command T1 back to the application program 10 (i.e., the electronic device 1).

After the application program 10 receiving the text command T1 via the electronic device 1, the application program 10 may determine type of the text command T1 based on its contents. In the embodiment, the application program 10 may determine whether the text command T1 is an image file command C1 for the image file database 4 or a printer command C2 for the 3D printer 2.

Specifically, after the user 5 inputting the voice command V1 for searching image files in the image file database 4 or downloading same, the application program 10 may determine that the text command T1 to be image file command C1. To the contrary, after the user 5 inputting the voice command V1 for controlling the 3D printer 2, the application program 10 may determine that the text command T1 to be printer command C2. In other words, contents of the image file command C1 is different from that of the printer command C2.

As shown in FIG. 2, the image file database 4 stores a plurality of image files 41. In the embodiment, the image file database 4 is a private or public database in a Cloud storage and stores a plurality of image files 41 for the 3D printer 2. The image file 41 is either 2D image file or 3D image file. For the image file 41 to be a 3D image file, the image file 41 may be, not limited to, an original image file such as an STL (STereoLithography) file, or a sliced image file (e.g., G code file).

In the invention, after the application program 10 determining that the received text command T1 to be the image file command C1, the application program 10 may transmit the image file command C1 to the image file database 4 via the wireless communication system. Next, the application program 10 may search the image files 41 in the image file database 4 based on the image file command C1 to find a desired image file G1. Once found, the image file G1 is sent to the electronic device 1.

After obtaining the desired image file G1, the application program 10 may transmit the image file G1 to the 3D printer 2 via the wireless communication system. Thus, the 3D printer 2 may perform a 3D printing of a 3D object based on the image file G1. In other embodiments, the 3D printer 2 may perform a 2D printing of an object based on the image file G1.

As described above, by utilizing the voice control system for 3D printer of the invention, a user 5 may issue a voice command V1 to search and download a desired image file G1 in the image file database 4. Specifically, in one embodiment, the voice command V1 and the image file command C1 can perform actions in the image file database 4 as tabulated below.

| | voice | |
|---|---|---|
| No. | command V1 | actions performed by image file database 4 |
| 1 | Search | enabling search in image file database 4 |
| 2 | Query Terms | searching an image file based on the input terms |
| 3 | Back | moving to a previous image file |
| 4 | Next | moving to a next image file |
| 5 | Download | downloading the selected image file |
| 6 | Open | opening the selected image file |

For example, with respect to the voice command V1 having number 1, the user 5 may issue the voice command V1 containing a “search” content to the application program 10. Next, the application program 10 transmits the voice command V1 to the voice recognition server 3 for analysis. A text command T1 having contents of “search” is obtained by the voice recognition server 3. Next, the application program 10 determines whether the text command T1 is an image file command C1 or not. If yes, the application program 10 transmits the image file command C1 to the image file database 4. After the image file database 4 receiving the image file command C1, the image file database 4 enables the “search” function based on the contents of the image file command C1.

Further, with respect to the voice command V1 having number 2, the user 5 may issue the voice command V1 containing an “automobile” content to the application program 10. Next, the application program 10 transmits the voice command V1 to the voice recognition server 3 for analysis. A text command T1 having contents of “automobile” is obtained by the voice recognition server 3. Next, the application program 10 determines whether the text command T1 is an image file command C1 or not. If yes, the application program 10 transmits the image file command C1 to the image file database 4. After the image file database 4 receiving the image file command C1, the image file database 4 enables a “search” function to find an image file G1 having the contents of “automobile” in the image files 41 based on the contents “automobile” of the image file command C1.

It is noted that in the embodiment, the image file database 4 may transmit an instant image of the found image file G1 to the electronic device 1 so that the user 5 may view images of the image file G1 on the screen of the electronic device 1. This enables the user 5 to decide whether to download the image file G1 or not.

In response to determining the received text command T1 to be a printer command C2 by the application program 10, the application program 10 transmits the printer command C2 to the 3D printer 2 via the wireless communication system. Thereafter, the 3D printer 2 begins to print as instructed by the printer command C2. Specifically, in one embodiment, the voice command V1 and the 3D printer 2 can perform actions based on the printer command C2 as tabulated below.

| No. | voice command V1 | actions performed by 3D printer 2 |
|---|---|---|
| 1 | Home | moving printer head to home position |
| 2 | Load | heating printer head and filling same with |
| | | filament |
| 3 | Unload | cooling printer head and unloading filament |
| 4 | Pause | temporarily stopping printing |
| 5 | Cancel | revoking printing |
| 6 | Continue | continuing printing |
| 7 | Power On | enabling 3D printer 2 |
| 8 | Power Off | disabling 3D printer 2 |

For example, with respect to the voice command V1 having number 2, the user 5 may issue the voice command V1 containing a “load” content to the application program 10. Next, the application program 10 transmits the voice command V1 to the voice recognition server 3 for analysis. A text command T1 having contents of “load” is obtained by the voice recognition server 3. Next, the application program 10 determines whether the text command T1 is a printer command C2 or not. If yes, the application program 10 transmits the printer command C2 to the 3D printer 2. After the 3D printer 2 receiving the printer command C2, the 3D printer 2 enables the “load” function to heat the printer head (not shown) and load filament (i.e., printing material) into the printer head based on the contents of the printer command C2.

As described above, the voice control system for 3D printer of the invention can activate all actions (including printing actions of the 3D printer 2 and searching/downloading actions of the image file database 4) except launching the application program 10 in the electronic device 1 through inputting the voice command V1, thereby greatly decreasing difficulties of operating the 3D printer 2.

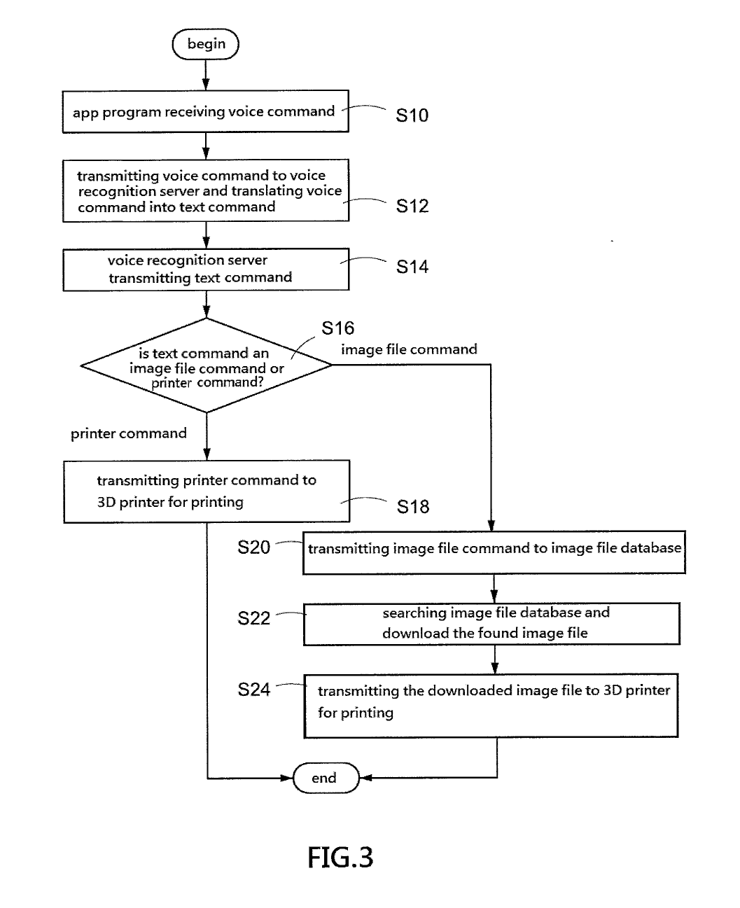

Referring to FIG. 3, a flow chart of a voice control method for using a voice control system for 3D printer according to the first embodiment of the invention is illustrated. FIG. 3 discloses a voice control method of the present invention, and the voice control method is adopted by the voice control system for 3D printer has been discussed in detail above by referring to FIGS. 1 and 2.

As illustrated in FIG. 3, the voice control method comprises the following steps:

Step S10 of launching an application program 10 to receive a voice command V1 in which specifically, in one embodiment the application program 10 is installed in an electronic device 1; and a microphone of the electronic device 1 receives the voice command V1.

Step S12 of performing the application program 10 to transmit the voice command V1 to a voice recognition server 3 in which the voice recognition server 3 does an analysis of the voice command V1 in order to translate the voice command V1 into a text command T1; and the text contents of the text command T1 is the same as the voice contents of the voice command V1.

It is noted that in step S10, the application program 10 performs a voice recording step by using the electronic device 1 in order to record the voice command V1 and generate a voice recording file. Further, in step S12, the application program 10 transmits the voice recording file to the voice recognition server 3 but not limiting.

Step S14 of causing the voice recognition server 3 to transmit the text command T1 back to the application program 10 (i.e., the electronic device 1).

Step S16 of performing the application program 10 to determine type of the text command T1 based on its contents. Specifically, the application program 10 determines whether the text command T1 is an image file command C1 or a printer command C2. If the determination is that the text command T1 is a printer command C2, the method continues with step S18. Otherwise, the method passes to step S20.

Step S18 of transmitting the printer command C2 to a 3D printer 2 to print a 3D object based on the printer command C2. The method ends subsequently. Specifically, in the embodiment the application program 10 takes the printer command C2 as an application programming interface (API) command which can control the 3D printer 2 for simulating the user 5 to manually operate the 3D printer 2.

Step S20 of performing the application program 10 to transmit the image file command C1 to the image file database 4.

Step S22 of performing the application program 10 to search image files in the image file database 4 based on the image file command C1, and downloading a found image file G1 which is desired by the user 5.

Step S24 of after the user 5 obtaining the desired image file G1, performing the application program 10 to transmit the image file G1 to the 3D printer 2 so that the 3D printer 2 may perform a 3D printing of a 3D object based on the image file G1. The method ends subsequently.

For example, the user 5 may issue a series of voice commands V1 such as “power on”, “load”, “home”, “search”, “automobile” and “download” to the application program 10.

In the embodiment, in response to receiving a voice command V1 of “power on” associated with the printer command C2, the application program 10 activates the 3D printer 2; in response to receiving a voice command V1 of “load” associated with the printer command C2, the 3D printer 2 heats a printer head and fills the printer head with filament; in response to receiving a voice command V1 of “home” associated with the printer command C2, the 3D printer 2 moves the printer head to home position; in response to receiving a voice command V1 of “search” associated with the image file command C1, the application program 10 enables a “search” function in the image file database 4; in response to receiving a voice command V1 of “automobile” associated with the image file command C1, the image file database 4 performs searching for an image file G1 having the contents of “automobile” in the image file database 4; in response to receiving a voice command V1 of “download” associated with the image file command C1, the application program 10 downloads the found image file G1 and transmits the image file G1 to the 3D printer 2 so that the 3D printer 2 may print a 3D model of an automobile based on the image file G1.

It is noted that the plurality of image files 41 in the image file database 4 are either original image files such as an STL (STereoLithography) files or sliced image files (e.g., G code files). For printing a 3D object by the 3D printer 2, it is required that the desired image file G1 to be printed by the 3D printer 2 be a sliced image file.

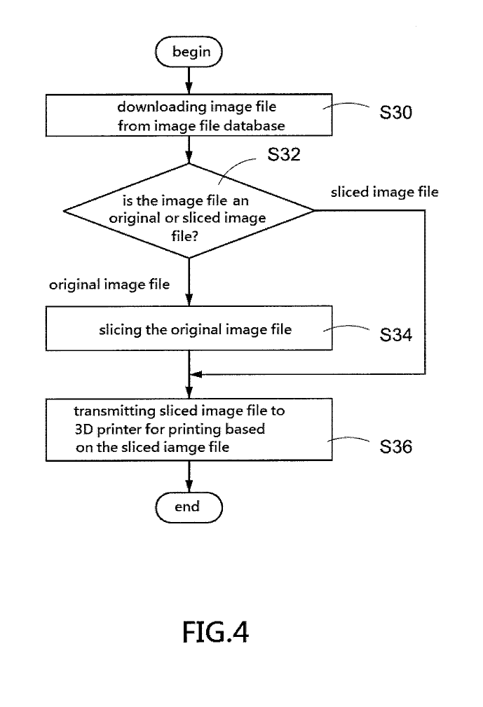

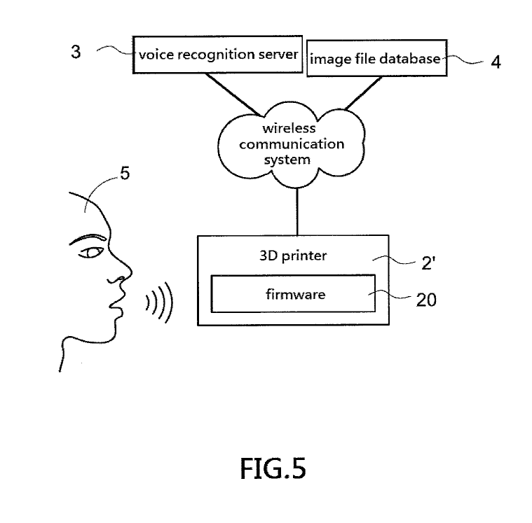

Referring to FIG. 4, it is a flow chart of processing an image file according to the first embodiment of the invention and the flow chart comprises the following steps:

Step S30 of performing the application program 10 to download the desired image file G1 from the image file database 4 after the image file database 4 completes the searching actions.

Step S32 of performing the application program 10 to determine the downloaded image file G1 to be the original image file or the sliced image file. If the determination is that the image file G1 is the original image file, the flow chart continues with step S34. Otherwise, the flow chart passes to step S36.

In the embodiment the image file G1 can be directly used by the 3D printer 2 if the image file G1 is the sliced image file. Thus, the application program 10 does not process the image file G1.

To the contrary, in step S34 the application program 10 performs a slice process on the original image file if the image file G1 is the original image file in order to translate the original image file into a sliced image file. The slice process of an image file is well known in the art and a detailed description thereof is omitted herein for the sake of brevity.

Step S36 of performing the application program 10 to transmit the sliced image file to the 3D printer 2 so that the 3D printer 2 may perform a 3D printing based on the sliced image file. As a result, a 3D object is printed by the 3D printer 2. The flow chart ends subsequently.

In the embodiment, the application program 10 is installed in an electronic device 1, a microphone of the electronic device 1 receives the voice command V1, and the application program 10 establishes a wireless communication between the electronic device 1 and each of the 3D printer 2, the voice recognition server 3, and the image file database 4.

Referring to FIG. 5, it is a block diagram of a voice control system for 3D printer according to a third embodiment of the invention. In the embodiment, an application program is not installed in an electronic device (such as the electronic device 1 mentioned above). Specifically, in the voice control system of the embodiment, the application program is installed in a 3D printer 2′ and the electronic device is not included in the voice control system of the embodiment. This has the advantage of decreasing the manufacturing cost without compromising the voice control function.

In the embodiment, the application program is installed in the 3D printer 2′. Specifically, the application program is incorporated into a firmware 20 in the 3D printer 2′ which is used to replace the electronic device 1 and the 3D printer 2 shown in FIGS. 1 and 2.

In the embodiment, a microphone (not shown) is provided in the 3D printer 2′. The firmware 20 can activates the microphone to receive a voice command V1 inputted by the user 5. The 3D printer 2′ further comprises a wireless communication module (not shown) for implementing a wireless communication with each the voice recognition server 3 and the image file database 4 via the wireless communication system. Thus, the firmware 20 may transmit the voice command V1, the text command T1, the image file command C1, and the desired image file G1 (as described in the description of FIGS. 1 and 2) to each of the voice recognition server 3 and the image file database 4 via the wireless communication system. Further, the firmware 20 may transmit the printer command C2 and the desired image file G1 to the 3D printer 2′ directly.

As described above, by utilizing the voice control system for 3D printer and voice control method for using the same of the invention, the user 5 may activate all actions (including printing actions of the 3D printer 2, 2′ and searching/downloading actions of the image file database 4) except launching the application program 10 (or the firmware 20) through inputting the voice command V1. It is envisaged by the invention that learning how to operate a 3D printer is made easy and the learning time is decreased greatly.

While the invention has been described in terms of preferred embodiments, those skilled in the art will recognize that the invention can be practiced with modifications within the spirit and scope of the appended claims.

What is claimed is:

1. A voice control method for using a voice control system for a three-dimensional (3D) printer, comprising the steps of:
(a) performing an application program to receive a voice command;
(b) performing the application program to transmit the voice command to a voice recognition server for translating the voice command into a text command;
(c) performing the application program to determine type of the text command based on its contents;
(d) after determining the type of the text command to be a printer command, transmitting the printer command to a 3D printer for controlling the 3D printer;
(e) after determining the type of the text command to be an image file command, performing the application program to transmit the image file command to an image file database, performing the application program to search a plurality of image files in the image file database based on the image file command, and downloading a found image file from the image file database; and
(f) performing the application program to transmit the downloaded image file to the 3D printer for creating a 3D object.

2. The voice control method of claim 1, wherein in step (a) the application program performs a voice recording step to record the voice command and generate a voice recording file; and in step (b) the application program transmits the voice recording file to the voice recognition server for analysis.

3. The voice control method of claim 2, wherein the application program is installed and performed in an electronic device; and in step (a) a microphone in the electronic device is configured to receive the voice command.

4. The voice control method of claim 2, wherein the application program is incorporated into a firmware in the 3D printer; and in step (a) a microphone in the 3D printer is configured to receive the voice command.

5. The voice control method of claim 1, wherein in step (e) the downloaded image file is either a G code file or a STereoLithography (STL) file.

6. The voice control method of claim 1, after step (e) further comprising the steps of:
(e1) determining whether the downloaded image file to be an original image file or a sliced image file;
(e2) after determining the downloaded image file to be the original image file, performing a slice process on the original image file to translate the original image file into the sliced image file; and
(e3) performing step (f) based on the sliced image file.

7. A voice control system for a 3D printer comprising:
an application program for receiving a voice command after being launched;
a voice recognition server configured to wirelessly communicate with the application program for translating the voice command into a text command which is transmitted back to the application program;
an image file database configured to wirelessly communicate with the application program, the image file database including a plurality of image files; and
a 3D printer;
wherein the application program is configured to determine type of the text command based on its contents, and after determining the type of the text command to be a printer command, transmit the printer command to the 3D printer for controlling the 3D printer; and
wherein after determining the type of the text command to be an image file command, the application program is configured to transmit the image file command to the image file database, search the plurality of image files in the image file database based on the image file command for obtaining a corresponding image file, download the found image file, and transmit the downloaded image file to the 3D printer for creating a 3D object.

8. The voice control system of claim 7, further comprising an electronic device configured to wirelessly communicate with each of the voice recognition server, the image file database, and the 3D printer, wherein the application program is installed and performed in the electronic device, the electronic device includes a microphone, and the application program is performed to activate the microphone to receive the voice command.

9. The voice control system of claim 7, wherein the 3D printer, the voice recognition server, and the image file database are wirelessly communicated one another, the application program is incorporated into a firmware in the 3D printer, the 3D printer includes a microphone, and the application program is performed to activate the microphone to receive the voice command.

10. The voice control system of claim 7, wherein the image files are either G code files or STereoLithography (STL) files.

11. The voice control system of claim 7, wherein the downloaded image file is either an original image file or a sliced image file, the application program performs a slice process on the original image file to translate the original image file into the sliced image file, and the 3D printer creates the 3D object based on the sliced image file.
